(19) United States
(12) Patent Application Publication
(10) Pub. No.: US 2026/0265082 A1
(43) Pub. Date: Sep. 10, 2026

(54) MEASUREMENT APPARATUS FOR AND METHOD OF DEWATERED SLUDGE

(71) Applicant: SENFIT OY, Oulu (FI)

(72) Inventors: Mikko VUOLTEENAHO, Oulu (FI); Vesa FISK, Oulu (FI); Pekka JAKKULA, Oulu (FI)

(21) Appl. No.: 19/162,877

(22) PCT Filed: Mar. 7, 2024
(86) PCT No.: PCT/EP2024/056057

§ 371 Date: Sep. 5, 2025

(30) Foreign Application Priority Data
Mar. 8, 2023 (FI) 20235267

(51) Int. Cl. C02F 1/00; C02F 11/121; G01N 1/04; G01N 1/28

(52) U.S. Cl. CPC C02F 1/008; C02F 11/121; G01N 1/04; G01N 1/286; C02F 2209/006; C02F 2209/01; C02F 2209/02; C02F 2209/05; C02F 2209/06; C02F 2209/10

(57) ABSTRACT

A measurement apparatus for dewatered sludge comprises a conveyor with a reception section and a measurement section. The conveyor receives continuously or repeatedly dewatered sludge from a dehydrator at the reception section, and conveys the dewatered sludge toward a measurement section, which comprises at least one sensor. The measurement section and the conveyor together compress the dewatered sludge at the measurement section. The at least one sensor measures the dewatered sludge at the measurement section. The conveyor causes a push force to the dewatered sludge at the measurement section based on feed of the dewatered sludge from the reception section for discharging the dewatered sludge from the measurement section back to the sludge process.

### FIELD

The invention relates to a measurement apparatus for and method of dewatered sludge.

### BACKGROUND

A purpose of wastewater treatment that may be performed in a municipal wastewater treatment plant, for example, is to separate solids and undesired content from wastewater for producing an effluent that is acceptable environmentally and/or recyclable. The solid material may also be recycled, burned in an energy plant or composted.

Separation of solid material may be performed using a dehydrator examples of which are a centrifugal dehydrator and band filters. The dehydrator outputs dehydrated dry solids continuously or as separate cakes. Samples are extracted from falling cake flow to a first conveyor that transfers the samples to a space outside the sludge process for a measurement. The first conveyor drops the dehydrated sludge to a second conveyor that transfers the dehydrated sludge to a measurement and after back to the sludge process.

There are challenges in this kind of sludge measurement system. The first screw conveyor causes the dewatered sludge to press against the sealant structures that are walls at the end of the first conveyor which requires a tight sealing. However, the sealing may be problematic. The discharge channel between the first and second conveyor may become clogged. To remove the clog, the motor of the first and second conveyor are typically run backwards but that does not necessarily solve the problem. The whole system for performing the measurement of the dewatered sludge is complicated and expensive. An improvement would be welcome.

### BRIEF DESCRIPTION

The present invention seeks to provide an improvement in the measurements.

The invention is defined by the independent claims. Embodiments are defined in the dependent claims.

If one or more of the embodiments is considered not to fall under the scope of the independent claims, such an embodiment is or such embodiments are still useful for understanding features of the invention.

### LIST OF DRAWINGS

Example embodiments of the present invention are described below, by way of example only, with reference to the accompanying drawings, in which

FIG. 1 illustrates an example a prior art apparatus for measuring dewatered sludge;

FIG. 2A illustrates an example an apparatus for measuring dewatered sludge;

FIG. 2B illustrates an example of the tapering section;

FIG. 3 illustrates an example of the apparatus for measuring dewatered sludge with a sampler for calibration;

FIGS. 4A and 4B illustrate examples of a roof for the measuring section;

FIG. 5 illustrates an example of the data processing and controlling unit;

FIG. 6 illustrates an example of the data processing unit; and

FIG. 7 illustrates of an example of a flow chart of a measuring method of the dewatered sludge.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment.

The articles “a” and “an” give a general sense of entities, structures, components, compositions, operations, functions, connections or the like in this document. Note also that singular terms may include pluralities.

Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction.

It should be noted that while Figures illustrate various embodiments, they are simplified diagrams that only show some structures and/or functional entities. The connections shown in the Figures may refer to logical or physical connections. It is apparent to a person skilled in the art that the described apparatus may also comprise other functions and structures than those described in Figures and text. It should be appreciated that details of some functions, structures, and the signaling used for measurement and/or controlling are irrelevant to the actual invention. Therefore, they need not be discussed in more detail here.

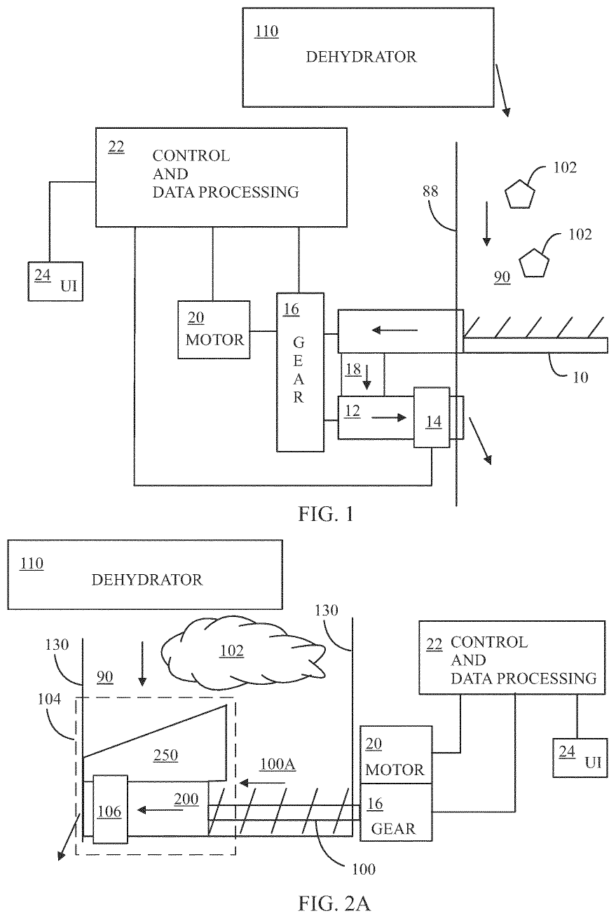

FIG. 1 illustrates an example of a prior art measurement system of dehydrated sludge of a wastewater treatment plant. The dehydrated sludge may be described as thick liquid, non-consistent solid or a dry cake. A person skilled in the art is familiar with the dehydrated sludge, per se. The dehydrator 110 outputs dehydrated sludge 102 continuously or as separate cakes, which fall down inside a discharge channel 90.

The samples are dropped from the dehydrator 110 to a first conveyor 10 that transfers the samples away from the sludge discharge channel 90 to a space that may be separated by a wall 88 from the discharge channel 90. At the end of the first conveyor 10 the dehydrated sludge is once more dropped to a second conveyor 12 that transfers the dehydrated sludge to a sensor unit 14 that measures the dehydrated sludge. After the measurement movement of the dehydrated sludge caused by the first and second conveyors 10, 12 makes the dehydrated sludge flow back to the sludge process.

The first conveyor 10 causes the dewatered sludge to press against a gear 16. The pressure requires a tight sealing of the rotation axel of the screw conveyor 10 or the like which may be problematic. Another problem is that the discharge channel 18 between the first conveyor 10 and the second conveyor 12 may become clogged. The motor 20 of the first and second conveyor 10, 12 requires an inverter or a reverse gear to run the conveyors 10, 12 backward to attempt a removal of the clog. The measurement system of the sludge can include a data processing and control unit 22 and a user interface 24.

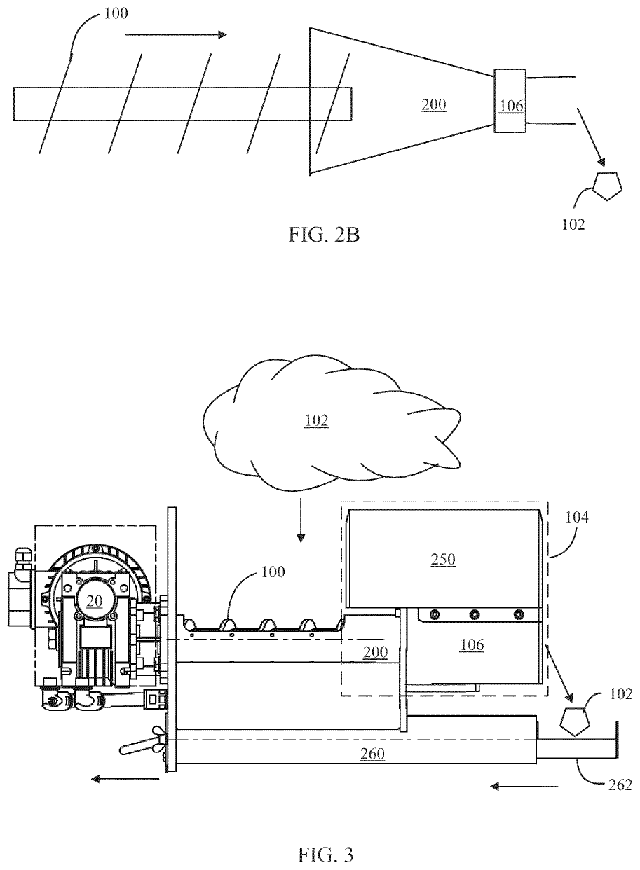

FIG. 2 illustrates an example of a measurement apparatus for dewatered sludge that differs technically from the prior art. The dehydrator 110 that may be similar to those known in the prior art may remove water from the sludge using filters and the dewatering effect may additionally be emphasized by pressure or vacuum. The dehydrator may alternatively or additionally comprise a centrifuge. Still, additionally the sludger may be thermally dried. A person skilled in the art is familiar with the dehydrator, per se.

The measurement apparatus comprises a conveyor 100 with a reception section 100A and a measurement section 104. The conveyor 100 is a means to transfer the sludge 102 in a mechanical manner.

The conveyor 100 receives continuously or repeatedly dewatered sludge 102 from a dehydrator 110 at the reception section 100A and conveys the dewatered sludge 102 toward a measurement section 104, which comprises at least one sensor 106. The conveyor 100 may comprise a conveyor belt a screw conveyor or a pneumatic or hydraulic piston, for example. A person skilled in the art is familiar with conveyors, per se.

The measurement section 104 and the conveyor 100 together compress the dewatered sludge 102 at the measurement section 104. The compression removes air and/or gas from the dewatered sludge 102 fully or partially. Some measurements are the more reliable the less there is air and/or gas within the dewatered sludge 102. The dewatered sludge 102 is also more compact and requires less space when air and/or gas is removed.

The at least one sensor 106 performs a measurement of the dewatered sludge 102 that is under compression or after compression at the measurement section 104. That is, the at least one sensor 106 senses or detects technically at least one property of the dewatered sludge 102.

The conveyor 100 causes a push force to the dewatered sludge 102 at the measurement section 104 based on feed of the dewatered sludge 102 from the reception section 100A and the push force enables and leads to a discharge of the dewatered sludge from the measurement section 104 back to the sludge process. The compression in the measurement section is also caused by the push force. The conveyor 100 that receives the dewatered sludge 102 from the dehydrator 110 causes the discharge of the dewatered sludge 102 back to the sludge process without dropping the dewatered sludge 102 from one conveyor to another conveyor. The conveyor 110 moves the dewatered sludge 102 without a back-and-forth movement of the dewatered sludge 102 and/or turning the direction of the movement of the dewatered sludge 102 to the opposite. Additionally, only one conveyor 110 is enough instead of two conveyors with opposite directions of transfer like that shown in FIG. 1.

The reception section 100A is limited by walls 130 for receiving the dewatered sludge 102. However, according to the solution of FIG. 2 there is no need to transfer the measured dewatered sludge 102 away from the sludge process and reception area. The apparatus is simpler and more compact than that of FIG. 1. The probability of clog and disturbance of the measurement is also lowered as such and also because of structural simplicity.

The received dewatered sludge 102 may be samples from the sludge process, the samples representing only a part of the total output of the dehydrator 11, or the received dewatered sludge 102 may be the total output of the dehydrator 110.

In an embodiment, the measurement section 104 may comprise a tapering structure 200. The tapering structure 200 becomes narrower in direction of movement of the dewatered sludge 102 for causing compression to the dewatered sludge 102 in response to propagation of the dewatered sludge 102 into the tapered structure 200. The compression reduces gas within the dewatered sludge 102 by causing gas, such as bubbles, to come out of the dewatered sludge or causing gas to dissolve in the dewatered sludge 102. The amount of dissolved gas in the dewatered sludge 102 is proportional to the pressure caused by the tapered structure 200 and/or other means of compression. The propagation of the dewatered sludge 102 into the tapered structure 200 being a result of the push force caused by the feed of the conveyor 100. The feed may be continuous.

In an embodiment, the measurement section 104 may comprise a roof 250 that covers the measurement section 104. The roof 250 may cut the sludge that is falling and shield the measurement section 104. The roof ridge can be in line with the conveyor or a longitudinal line of the ridge may deviate from a direction of the conveyor. The ridge and the conveyor may have transverse directions, and an angle therebetween be about 90 degrees. The roof 250 restricts deposition of the dewatered sludge 102 on the measurement section 104 based on a tilt angle α of the roof 250. The tilt angle α can be considered an angular difference with respect to a vertical line. The vertical line, in turn, can be considered parallel to a gravitational force G. The tilt angle α is steep enough for causing gravitational removal of the dewatered sludge 102 from the roof 250. The dewatered sludge 102 may be sticky and it may be viscously deposited on the roof and attached to the roof 250. The gravitation, viscosity of the dewatered sludge, the tilt angle α and area of the roof 250 define a threshold or maximum amount of mass of the dewatered sludge 102 that can deposit on the roof 250. A larger amount of the dewatered sludge 102 falls off the roof 250 at least on average because of the tilt angle α. By limiting the amount of the dewatered sludge 102 on the roof 250 with the tilt angle α, it is possible to reduce a probability of or prevent clogging the measurement and/or sampling. The tilt angle α may be smaller than about 15°, for example. However, a suitable tilt angle α depends on the sludge 102.

FIG. 3 illustrates an example of the apparatus for measuring the dewatered sludge 102. The apparatus may comprise a calibration sampler 260 that takes a calibration sample of the dewatered sludge 102 that has been measured by the at least one sensor 106. The calibration sampler 260 may operate manually or automatically. The calibration sample taken by the calibration sampler 260 may be analyzed in a laboratory, for example. The measurements of the at least one sensor 106 may be calibrated by the analysis of the calibration sample taken by the calibration sampler 260. The calibration sampler 260 may have a groove 262 that moves back and forth, for example. When the groove 262 is moved under the discharge from the at least one sensor 106, the groove may receive at least a part of the discharge. The groove 262 with the calibration sample may then be pulled backwards and taken to the laboratory.

In an embodiment an example of which is illustrated in FIG. 3, the conveyor 100 may comprise a screw conveyor. In an embodiment, the conveyor 100 may be a pneumatic or hydraulic piston that moves back and forth.

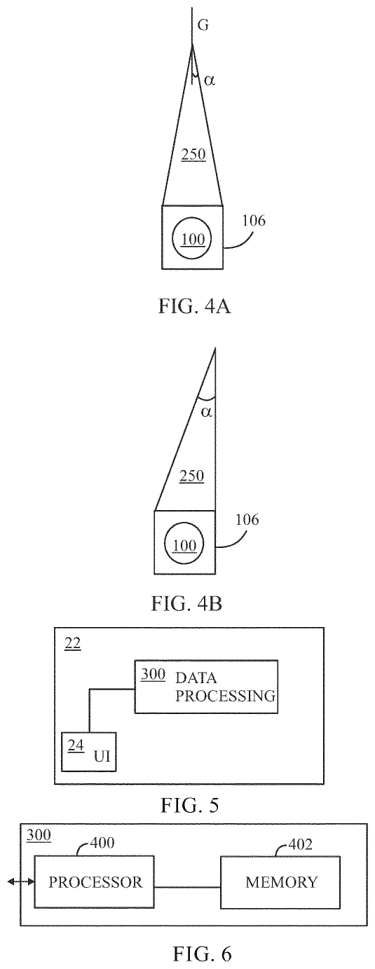

In an embodiment an example of which is illustrated in FIG. 4A, the roof 250 may comprise a ridged roof, while the reception section 100A receives falling cakes of the dewatered sludge 102. A ridge of the ridged may cut the falling cakes of the dewatered sludge 102 into pieces and let the amount equal to or larger than the threshold continue to travel to the sludge process from the roof 250.

In an embodiment an example of which is illustrated in FIG. 4B, the roof 250 may comprise a lean roof while the reception section 100A receives falling cakes of the dewatered sludge 102. A higher edge of the lean roof may cut the falling cakes of the dewatered sludge 102 into pieces and let the amount equal to or larger than the threshold continue to travel to the sludge process from the roof 250.

In an embodiment, the at least one sensor 106 may to sense at least one of the following: water content, dry stuff content, pH, characteristic of one or more microbes, one or more chemicals, radioactivity, temperature, electrical conductivity, and density. The sensing of the at least one sensor 106 does not need to limit to these because the treatment of the dewatered sludge 102 makes it possible to utilize one or more of a large variety of measurements.

The measurement may be electrical or optical. The optical measurement may be based on transmission through at least a part of the dewatered sludge 102, reflection or scattering from the dewatered sludge 102, detection of at least partially the same wavelength band as the light directed to the dewatered sludge or detection of at least one wavelength outside an optical band directed to the dewatered sludge 102 for the measurement (such as fluorescence and/or Raman radiation).

The water content can be understood as a percentage of water that can or could evaporate when the dewatered sludge 102 is heated. The percentage may refer to mass percentage although it may also mean volume percentage. The water of the dewatered sludge 102 is typically absorbed and/or chemically bonded. Water content may be measured using known methods which may be electrical and/or may include electromagnetic radiation such as microwave radiation and/or optical radiation. A measurement of moisture content additionally or alternatively gives information on dry stuff content. By measuring pH it is possible to get information on how acid or alkalic the dewatered sludge 102 is. The measurement may be performed electrically. Microbes may also be measured electrically and/or optically directly or indirectly.

In an embodiment an example of which is illustrated in FIG. 5, the apparatus may comprise a data processing unit 300 that forms data on at least one of the following of the dewatered sludge based on measurement of the at least one sensor 106: water content, pH, dry stuff content, one or more microbes, one or more chemicals, radioactivity, temperature, electrical conductivity, and density, and present the data through a user interface 302.

In an embodiment an example of which is illustrated in FIG. 6, the data processing unit 300 may comprise one or more processors 400, and one or more memories 402 including computer program code. The one or more memories 402 and the computer program code may, with the one or more processors 400, cause the apparatus at least to receive signals from the at least one sensor 106, form data relating to the dewatered sludge based on signaling from the at least one sensor 106, and present the data through the user interface 302.

The term “computer” includes a computational device that performs logical and arithmetic operations. For example, a “computer” may comprise an electronic computational device, such as an integrated circuit, a microprocessor, a mobile computing device, a laptop computer, a tablet computer, a personal computer, or a mainframe computer. A “computer” may comprise a central processing unit, an ALU (arithmetic logic unit), a memory unit, and a control unit that controls actions of other components of the computer so that steps of a computer program are executed in a desired sequence. A “computer” may also include at least one peripheral unit that may include an auxiliary memory (such as a disk drive or flash memory), and/or may include data processing circuitry.

A user interface means an input/output device and/or unit. Non-limiting examples of a user interface include a touch screen, other electronic display screen, keyboard, mouse, microphone, handheld electronic controller, digital stylus, display screen, speaker, and/or projector for projecting a visual display.

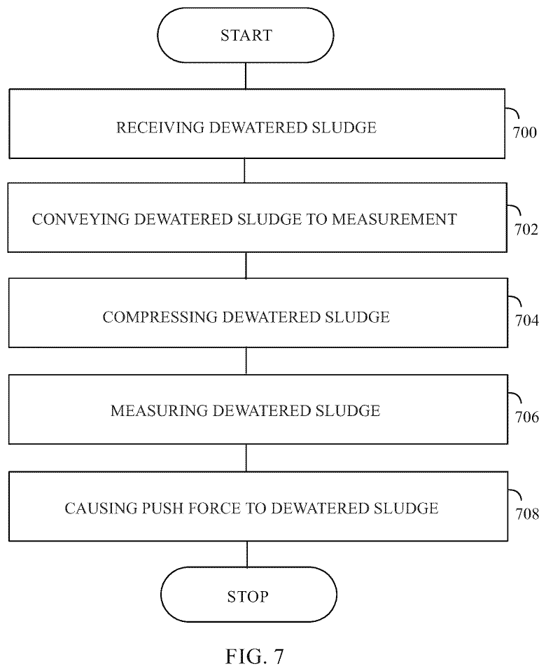

FIG. 7 is a flow chart of the measurement method of the dewatered sludge 102. In step 700, the dewatered sludge 102 is received continuously or repeatedly from a dehydrator 110 at a reception section 100A by a conveyor 100.

In step 702, the dewatered sludge 102 is conveyed toward a measurement section 104, which comprises at least one sensor 106.

In step 704, the dewatered sludge 102 is compressed together by the measurement section 104 and the conveyor 100 at the measurement section 104.

In step 706, the dewatered sludge 102 under compression at the measurement section 104 is measured by the at least one sensor 106.

In step 708, a push force is caused to the dewatered sludge 102 at the measurement section 104 based on feed of the dewatered sludge 102 from the reception section 100A by the conveyor 100 for discharging the dewatered sludge from the measurement section 104 back to the sludge process.

Additionally in the method, the measurement section 104 may be protected by a roof 250 that covers the measurement section 104. The roof 250 restricts deposition of the dewatered sludge 102 on the measurement section 104 based on a tilt angle of the roof 250 that is allows gravitational removal of the dewatered sludge 102 from the roof 250, the gravitation, viscosity of the dewatered sludge and the tilt angle defining a threshold amount of the dewatered sludge 102 a larger amount of which falls off the roof 250. The method may include one or more of the features already revealed with explanation of FIGS. 1 to 5.

The method shown in FIG. 7 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium which may be any medium readable by the controller. The medium may be a program storage medium, a memory, a software distribution package, or a compressed software package. In some cases, the distribution may be performed using at least one of the following: a near field communication signal, a short distance signal, and a telecommunications signal.

It will be obvious to a person skilled in the art that, as technology advances, the inventive concept can be implemented in various ways. The invention and its embodiments are not limited to the example embodiments described above but may vary within the scope of the claims.

1. A measurement apparatus for dewatered sludge of wastewater treatment, wherein the measurement apparatus comprises a conveyor with a reception section and a measurement section;
the conveyor is configured to receive continuously or repeatedly dewatered sludge from a dehydrator at the reception section limited by walls, and convey the dewatered sludge toward a measurement section which comprises at least one sensor;
the measurement section and the conveyor together are configured to remove air and/or gas from the dehydrated sludge by compression of the dewatered sludge at the measurement section;
the at least one sensor is configured to measure a property of the dewatered sludge at the measurement section, the property being at least water content; and
the conveyor that is configured to receive the dewatered sludge is configured to cause a push force to the dewatered sludge at the measurement section based on feed of the dewatered sludge from the reception section for discharge of the dewatered sludge from the measurement section back to the sludge process.

2. The apparatus of claim 1, wherein the measurement section comprising a tapering structure in direction of movement of the dewatered sludge for causing compression to the dewatered sludge in response to propagation of the dewatered sludge into the tapered structure for reducing gas within the dewatered sludge the propagation of the dewatered sludge into the tapered structure being a result of the push force caused by the feed of the conveyor

3. The apparatus of claim 1, wherein the measurement section comprising a roof that is configured to cover the measurement section;
the roof is configured to restrict deposition of the dewatered sludge on the measurement section based on a tilt angle of the roof that is configured to allow gravitational removal of the dewatered sludge from the roof, the gravitation, viscosity of the dewatered sludge and the tilt angle defining a threshold amount of the dewatered sludge a larger amount of which is configured to fall off the roof.

4. The apparatus of claim 3, wherein the roof comprises a ridged roof and the reception section being configured to receive falling cakes of the dewatered sludge; a ridge of the ridged roof being configured to cut the falling cakes of the dewatered sludge into pieces.

5. The apparatus of claim 3, wherein the roof comprises a lean roof and the reception section being configured to receive falling cakes of the dewatered sludge; a higher edge of the lean roof being configured to cut the falling cakes of the dewatered sludge into pieces.

6. The apparatus of claim 1, wherein the at least one sensor is configured to sense at least one of the following: dry stuff content, pH, characteristic of one or more microbes, one or more chemicals, radioactivity, temperature, electrical conductivity, and density.

7. The apparatus of claim 1, wherein the apparatus comprises a calibration sampler that is configured to take a calibration sample of the dewatered sludge measured by the at least one sensor for an analysis in a laboratory.

8. The apparatus of claim 1, wherein the apparatus comprises a data processing unit that is configured to form data on at least one of the following of the dewatered sludge based on measurement of the at least one sensor: water content, dry stuff content, one or more microbes, one or more chemicals, radioactivity, temperature, electrical conductivity, and density, and present the data through a user interface.

9. The apparatus of claim 8, wherein the data processing unit comprises one or more processors, and one or more memories including computer program code;
the one or more memories and the computer program code configured to, with the one or more processors, cause the apparatus at least to:
receive signals from the at least one sensor; form data relating to the dewatered sludge based on signaling from the at least one sensor; and
present the data through the user interface.

10. The apparatus of claim 1, wherein the conveyor comprises a screw conveyor.

11. A measurement method of dewatered sludge of wastewater treatment, the method comprising
receiving, by a conveyor, continuously or repeatedly dewatered sludge from a dehydrator at a reception section limited by walls
conveying the dewatered sludge toward a measurement section, which comprises at least one sensor;
removing air and/or gas from the dehydrated sludge by compression, together by the measurement section and the conveyor, the dewatered sludge at the measurement section;
measuring, by the at least one sensor, at least one property of the dewatered sludge under compression at the measurement section, the property being at least water content; and
causing a push force to the dewatered sludge at the measurement section based on feed of the dewatered sludge from the reception section by the conveyor for discharging the dewatered sludge from the measurement section back to the sludge process.

12. The method of claim 11, the method further comprising protecting the measurement section by a roof that is configured to cover the measurement section;
restricting, by the roof, deposition of the dewatered sludge on the measurement section based on a tilt angle of the roof that is allows gravitational removal of the dewatered sludge from the roof, the gravitation, viscosity of the dewatered sludge and the tilt angle defining a threshold amount of the dewatered sludge a larger amount of which falls off the roof.

13. The method of claim 11, the method further comprising causing, by a tapering structure of the measurement section, compression to the dewatered sludge in direction of movement of the dewatered sludge in response to propagation of the dewatered sludge into the tapered structure for reducing gas within the dewatered sludge, the propagation of the dewatered sludge into the tapered structure being a result of the push force caused by the feed of the conveyor.

14. The method of claim 11, the method further comprising cutting by a ridge of a ridged roof or a higher edge of a lean roof that covers the measurement section falling cakes of the dewatered sludge into pieces.

15. The method of claim 11, the method further comprising sensing by the at least one sensor at least one of the following:
dry stuff content, characteristic of one or more microbes, one or more chemicals, radioactivity, temperature, electrical conductivity, and density; and forming and presenting data thereon.
